(19) United States
(12) Patent Application Publication
(10) Pub. No.: US 2007/0172624 A1
(43) Pub. Date: Jul. 26, 2007

(54) Optical recording materials writable using blue lasers

(76) Inventors: Heinz Wolleb, Fehren (CH); Annemarie Wolleb, Fehren (CH); Frank Bienewald, Hegenheim (FR); Beat Schmidhalter, Bubendorf (CH); Jean-Luc Budry, Courroux (CH); Heinz Spahni, Frenkendorf (CH)

Correspondence Address: CIBA SPECIALTY CHEMICALS CORPORATION;PATENT DEPARTMENT, 540 WHITE PLAINS RD, P O BOX 2005, TARRYTOWN, NY, 10591-9005, US

(21) Appl. No.: 10/590,021

(22) PCT Filed: Feb. 16, 2005
(86) PCT No.: PCT/EP05/50673

§ 371 Date: Aug. 21, 2006

(30) Foreign Application Priority Data
Feb. 24, 2004 (EP) 04100711.3

(51) Int. Cl. B32B 3/02

(52) U.S. Cl. 428/64.4

(57) ABSTRACT

The invention relates to an optical recording medium comprising a substrate, a recording layer and optionally one or more reflecting layers, wherein the recording layer comprises a compound of formula (I) or a tautomeric or mesomeric form thereof, wherein G₁ and G₂ are each independently of the other C(R₅) or N; M₁ is a lanthanide or transition metal of groups 4 to 10; P is a phthalocyanino diradical; and R₁ to R₅ are substituents as defined in the description and the claims. Recording and playback are effected especially at a wavelength of from 350 to 500 nm, for example using a blue laser. The recording and playback quality is excellent and allows a high storage density.

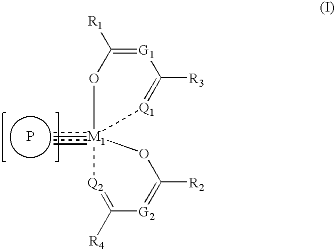

The invention relates to new optical recording materials that have excellent recording and playback quality especially at a wavelength of 350-500 nm. Recording and playback can be effected very advantageously with high sensitivity at the same wavelength, and the storage density that is achievable is significantly higher than in the case of known materials. In addition, the materials according to the invention have very good storage properties before and after recording, even under especially harsh conditions, such as exposure to sunlight or fluorescent lighting, heat and/or high humidity. In addition, their manufacture is simple and readily reproducible using customary coating processes, such as spin-coating.

Phthalocyanines are known for their good properties for optical recording in the near infrared range.

Substituted phthalocyanines proposed for that purpose include those the central atom of which comprises a trivalent or higher valency semi-metal or metal bonded to one or more further ligands. For example, JP-03/077 840 and JP-03/100 066 respectively disclose silicon and tin phthalocyanines that have an acyl group on the semi-metal or metal on both sides of the phthalocyanine nucleus.

Furthermore, JP-A-09/226,248 and JP-A-09/226,249 disclose also titanium (actually TiO) and zirconium as central elements, with JP-A-09/226,249 also describing oxalyl radicals as acyl ligands of the central element. Both cases, however, represent awkward reversible systems which do not sufficiently meet the requirements of most users.

Amongst many other metals, EP 0 381 211 mentions hafnium as central atom, but without any indication of the possible ligands. SPIE Proceedings 3359, 479-483 (1998) discloses optical recording media having a layer on unsubstituted H₂—, V^{IV}O—, Hf^{II}- or Lu^{II}-phthalocyanine in PTFE, in which holes can be formed by laser ablation or by sublimation.

JP-A-61/246 091 discloses that highly substituted phthalocyanines having oxo- and thio-metals as central atoms, including Hf^{IV}O, are suitable for recording in the near IR range.

Although phthalocyanines exhibit absorption maxima also at lower wavelengths, they generally have little suitability for more recent systems such as DVD±R (635 to 658 nm) or so-called “blue lasers” (about 405 nm). WO-03/019 548 nevertheless proposes Si-, Ge- and Sn-phthalocyanines with axial halide ligands. Those colorants have to be applied by vapour deposition, however, so that they are present in a suitable crystal modification. In practice, however, it is desirable to have colorants that can be applied by spin-coating and yield a layer that is as amorphous as possible.

Further optical recording materials writable using a blue laser are also disclosed in WO-03/030 158, wherein inter alia di-trimethylsiloxy-zirconium phthalocyanine and diethoxy-ruthenium phthalocyanine are applied in this case too by sublimation. In WO-03/030 158, however, it is primarily not the colorant but the thickness of the covering layer and the numerical aperture that are important.

The problem underlying the invention was to provide an optical recording medium having high information density, sensitivity and data reliability. Such a recording medium should be robust, durable and easy to use. Furthermore, it should be inexpensive to manufacture as a mass-produced product and should require equipment that is as small and inexpensive as possible. The surprising solution was the use of phthalocyanines having robustly complexed heavy metals.

The invention therefore relates to an optical recording medium comprising a substrate, a recording layer and optionally one or more reflecting layers, wherein the recording layer comprises a compound of formula 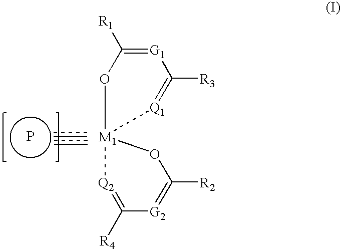
or a tautomeric or mesomeric form thereof, wherein
G₁ and G₂ are each independently of the other C(R₅) or N;
M₁ is a lanthanide or transition metal of groups 4 to 10;
\textcircled{P} is a phthalocyanino diradical;
Q₁ and Q₂ are each independently of the other O or S,
R₁ and R₂ are each independently of the other C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₀aryl, C₁-C₉heteroaryl, C₇-C₁₂aralkyl or C₂-C₁₂heteroaralkyl each unsubstituted or substituted by one or more, where applicable identical or different, radicals R₇;
R₃ and R₄ are each independently of the other hydrogen, hydroxy, S—R₈, O—R₈, O—CO—R₈, OCOOR₈, NH₂, NH—R₈, NR₈R₉, NHCOR₈, NR₈COR₁₀, NHCOOR₈, NR₈COOR₁₀, ureido, NR₈—CO—NHR₁₀, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₀aryl, C₁-C₉heteroaryl, C₇-C₁₂aralkyl or C₂-C₁₂heteroaralkyl each unsubstituted or substituted by one or more, where applicable identical or different, radicals R₇;
each R₅, independently of any other R₅, is hydrogen, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₀aryl, C₁-C₉heteroaryl, C₇-C₁₂aralkyl or C₂-C₁₂heteroaralkyl each unsubstituted or substituted by one or more, where applicable identical or different, radicals R₇;
wherein R₁ and R₂, R₂ and R₃, R₃ and R₄ or R₁ and R₄ can be linked by a bonding member, or two of R₁, R₂, R₃ and R₄ can each be linked by a bonding member to one of the two other R₁, R₂, R₃ and R₄ to form pairs, and each bonding member is a direct bond or a bridge O, S or N(R₈); or
R₁ forms with R₅ of G₁ and/or R₃ forms with R₅ of G₂ a saturated, mono- or poly-unsaturated or aromatic 5- or 6-membered ring which may optionally contain 1, 2 or 3 identical or different hetero atoms —O—, —S—, —N═ or —N(R₈)—, which ring is unsubstituted or substituted by one or more, where applicable identical or different, radicals R₇; and/or
R₂ forms with R₅ of G₁ and/or R₄ forms with R₅ of G₂ a saturated or mono- or poly-unsaturated 5- or 6-membered ring which may optionally contain 1, 2 or 3 identical or different hetero atoms —O—, —S—, —N═ or —N(R₈)—, which ring is unsubstituted or substituted by one or more, where applicable identical or different, radicals R₆;
R₆ is halogen, hydroxy, O—R₁₁, O—CO—R₁₁, oxo, S—R₁₁, thioxo, NH₂, NH—R₁₁, NR₁₁R₁₂, NH₃⁺, NH₂R₁₁⁺, NHR₁₁R₁₂⁺, NR₁₁R₁₂R₁₃⁺, NR₁₁—CO—R₁₃, NR₁₁COOR₁₃, cyano, formyl, COO—R₁₁, carboxy, carbamoyl, CONH—R₁₁, CONR₁₁R₁₂, ureido, NH—CO—NHR₁₃, NR₁₁—CO—NHR₁₃, phosphato, P(═O)R₁₁R₁₃, POR₁₁OR₁₃, OPR₁₁R₁₃, OPR₁₁OR₁₃, P(═O)R₁₁OR₁₃, P(═O)OR₁₁OR₃, OP(═O)R₁₁OR₁₃, OP(═O)OR₁₁OR₁₃, OPO₃R₁₁, SO₂R₁₁, sulfato, sulfo, R₁₄, N═N—R₁₄, or C₁-C₈alkoxy or C₃-C₈cycloalkoxy each unsubstituted or mono- or poly-substituted by halogen;
R₇, independently of any other R₇, is R₁₅, halogen, nitro, cyano, thiocyano, hydroxy, S—R₈, O—R₈, O—CO—R₈, OCOOR₈, NH₂, NH—R₈, NR₈R₉, NHCOR₈, NR₈COR₁₀, NHCOOR₈, NR₈COOR₁₀, ureido, NR₈—CO—NHR₁₀, NH₃⁺, NH₂R₈⁺, NHR₈R₉⁺, NR₈R₉R₁₀⁺, N═N—R₁₅, N═CR₈R₉, N═CR₁₆R₁₇, C(R₁₈)═NR₈, C(R₁₈)═NR₁₆, C(R₁₈)═CR₁₆R₁₇, CHO, CHOR₈OR₁₀, COR₉, CR₉OR₈OR₁₀, CONH₂, CONHR₈, CONR₈R₉, SO₂R₈, SO₃R₈, SO₂NH₂, SO₂NHR₈, SO₂NR₈R₉, COOH, COOR₈, B(OH)₂, B(OH)(OR₈), B(OR₈)OR₁₀, phosphato, P(═O)R₈R₁₀, POR₈OR₁₀, P(═O)R₈OR₁₀, P(═O)OR₈OR₁₀, OPR₈R₁₀, OPR₈OR₁₀, OP(═O)R₈OR₁₀, OP(═O)OR₈OR₁₀, OPO₃R₈, sulfato, sulfo, or C₁-C₅alkyl, C₃-C₆cycloalkyl, C₁-C₅alkylthio, C₃-C₆cycloalkylthio, C₁-C₅alkoxy or C₃-C₆cycloalkoxy each unsubstituted or substituted by one or more, where applicable identical or different, radicals R₆;
R₈, R₉ and R₁₀ are each independently of the others R₁₅, R₁₉—[O—C₁-C₄alkylene]ₘ, R₁₉—[NH—C₁-C₄alkylene]ₘ, or C₁-C₈alkyl, C₃-C₈cycloalkyl, C₂-C₈alkenyl or C₃-C₈cycloalkenyl each unsubstituted or substituted by one or more, where applicable identical or different, halogen, hydroxy, C₁-C₅alkoxy or C₃-C₆cycloalkoxy radicals; or
R₈ and R₉ together with the common nitrogen are pyrrolidine, piperidine, piperazine or morpholine, each of which is unsubstituted or mono- to tetra-substituted by C₁-C₄alkyl; or
R₈ and R₁₀ together are C₂-C₈alkylene, C₃-C₈cycloalkylene, C₂-C₈alkenylene or C₃-C₈cycloalkenylene, each of which is unsubstituted or substituted by one or more, where applicable identical or different, halogen, hydroxy, C₁-C₅alkoxy or C₃-C₆cycloalkoxy radicals;
R₁₁, R₁₂ and R₁₃ are each independently of the others C₁-C₈alkyl, C₃-C₈cycloalkyl, C₂-C₈alkenyl, C₃-C₈cycloalkenyl, R₁₉—[O—C₁-C₄alkylene]ₘ, R₁₉—[NH—C₁-C₄alkylene]ₘ, C₆-C₁₀aryl, C₄-C₉heteroaryl, C₇-C₁₀aralkyl or C₅-C₉heteroaralkyl; or
R₁₁ and R₁₂ together with the common nitrogen are pyrrolidine, piperidine, piperazine or morpholine, each of which is unsubstituted or mono- to tetra-substituted by C₁-C₄alkyl;
R₁₄ is C₆-C₁₂aryl, C₄-C₁₂heteroaryl, C₇-C₁₂aralkyl or C₅-C₁₂heteroaralkyl, each of which is unsubstituted or substituted by one or more, where applicable identical or different, radicals R₇;
R₁₅ is phenyl, C₄-C₅heteroaryl, C₇-C₈aralkyl or C₅-C₇heteroaralkyl, each of which is unsubstituted or substituted by one or more, where applicable identical or different, radicals R₂₀;
R₁₆ and R₁₇ are each independently of the other NR₁₁R₁₂, CN, CONH₂, CONHR₈, CONR₈R₉ or COOR₉;
R₁₈ is R₁₅, hydrogen, cyano, hydroxy, C₁-C₁₂alkoxy, C₃-C₁₂cycloalkoxy, C₁-C₁₂alkylthio, C₃-C₁₂cycloalkylthio, amino, NHR₁₃, NR₁₁R₁₂, halogen, nitro, formyl, COO—R₁₁, carboxy, carbamoyl, CONH—R₁₁, CONR₁₁R₁₂, or C₁-C₈alkyl, C₃-C₈cycloalkyl, C₂-C₈alkenyl or C₃-C₈cycloalkenyl each unsubstituted or substituted by one or more, where applicable identical or different, halogen, hydroxy, C₁-C₅alkoxy or C₃-C₆cycloalkoxy radicals; or
R₈ and R₁₈ together are C₂-C₈alkylene, C₃-C₈cycloalkylene, C₂-C₈alkenylene or C₃-C₈cycloalkenylene, each of which is unsubstituted or substituted by one or more, where applicable identical or different, halogen, hydroxy, C₁-C₅alkoxy or C₃-C₆cycloalkoxy radicals;
R₁₉ is hydrogen, C₁-C₄alkyl or C₁-C₃alkylcarbonyl;
R₂₀ is nitro, SO₂NHR₁₁, SO₂NR₁₁R₁₂, or C₁-C₈alkyl, C₃-C₈cycloalkyl, C₁-C₈alkylthio, C₃-C₈cycloalkylthio, C₁-C₈alkoxy or C₃-C₈cycloalkoxy each unsubstituted or substituted by one or more, where applicable identical or different, halogen, hydroxy, C₁-C₅alkoxy or C₃-C₆cycloalkoxy radicals; and
m is a number from 1 to 4.

Suitable lanthanide and transition metals are, for example, Ti, V, Mn, Zr, Nb, Mo, Ru, Ce, Pr, Tb, Hf, W, Re, Os, Ir and Pt. It is particularly advantageous to use the lanthanide and transition metals according to the invention in oxidation state III, IV, V or VI but, independently of the ligand-substituents, always preferably in oxidation state IV, that is to say, for example, Ti⁴⁺, Zr⁴⁺ or Hf⁴⁺, more especially Zr⁴⁺.

It will be understood that acidic groups, such as carboxy, sulfo, sulfato and phosphato, may also be in the form of a salt, for example an alkali metal, alkaline earth metal, ammonium or phosphonium salt, such as Li⁺, Na⁺, K⁺, Mg²⁺, Ca²⁺, Cu²⁺, Ni²⁺, Fe²⁺, Co²⁺, Zn²⁺, Sn²⁺, La³⁺, NH₄⁺, NH₃R₁₁⁺, NH₂R₁₁R₁₂⁺, NHR₁₁R₁₂R₁₃⁺, NR₈R₁₁R₁₂R₁₃⁺, PR₈R₁₁R₁₂R₁₃⁺, or any of the cations B-1 to B-169 mentioned in U.S. Pat. No. 6,225,024, to which individually reference is expressly made here.

Examples of ammonium and phosphonium groups that may be given special mention include ammonium, methylammonium, ethylammonium, isopropylammonium, dicyclohexylammonium, tetramethylammonium, tetraethylammonium, tetrabutylammonium, benzyltrimethylammonium, benzyltriethylammonium, methyltrioctylammonium, tridodecylmethylammonium, ™Primene 81-R, ™Rosin Amine D, pentadecylammonium, ™Primene JM-T, tetrabutylphosphonium, tetraphenylphosphonium, butyltriphenylphosphonium and ethyltriphenylphosphonium.

Halogen is chlorine, bromine, fluorine or iodine, preferably fluorine or chlorine, especially fluorine on alkyl (for example trifluoromethyl, α,α,α-trifluoroethyl or perfluorinated alkyl groups, such as heptafluoropropyl) and chlorine on aryl, heteroaryl or on the aryl moiety of aralkyl or on the heteroaryl moiety of heteroaralkyl.

Alkyl, cycloalkyl, alkenyl and cycloalkenyl can be straight-chain or branched, or monocyclic or polycyclic. Alkyl is, for example, methyl, straight-chain C₂-C₁₂alkyl or preferably branched C₃-C₁₂alkyl. Alkenyl is, for example, straight-chain C₂-C₁₂alkenyl or preferably branched C₃-C₁₂alkenyl.

The invention therefore relates especially also to compounds of formula (I) containing branched C₃-C₁₂alkyl or branched C₃-C₁₂alkenyl, and also to optical recording materials comprising such compounds. C₁-C₁₂Alkyl is therefore, for example, methyl, ethyl, n-propyl, isopropyl, n-butyl, sec-butyl, isobutyl, tert-butyl, n-pentyl, 2-pentyl, 3-pentyl, 2,2-dimethylpropyl, n-hexyl, n-octyl, 1,1,3,3-tetramethylbutyl, 2-ethylhexyl, nonyl, decyl or dodecyl. C₃-C₁₂Cycloalkyl is, for example, cyclopropyl, cyclobutyl, cyclopentyl, cyclohexyl, trimethylcyclohexyl, menthyl, thujyl, bornyl, 1-adamantyl or 2-adamantyl.

C₂-C₁₂Alkenyl or C₃-C₁₂cycloalkenyl is respectively C₂-C₁₂alkyl or C₃-C₁₂cycloalkyl that is mono- or poly-unsaturated, wherein two or more double bonds may be isolated or conjugated, for example vinyl, allyl, 2-propen-2-yl, 2-buten-1-yl, 3-buten-1-yl, 1,3-butadien-2-yl, 2-cyclobuten-1-yl, 2-penten-1-yl, 3-penten-2-yl, 2-methyl-1-buten-3-yl, 2-methyl-3-buten-2-yl, 3-methyl-2-buten-1-yl, 1,4-pentadien-3-yl, 2-cyclopenten-1-yl, 2-cyclohexen-1-yl, 3-cyclohexen-1-yl, 2,4-cyclohexadien-1-yl, 1-p-menthen-8-yl, 4(10)-thujen-10-yl, 2-norbornen-1-yl, 2,5-norbornadien-1-yl, 7,7-dimethyl-2,4-norcaradien-3-yl or the various isomers of hexenyl, octenyl, nonenyl, decenyl or dodecenyl.

C₇-C₁₂Aralkyl is, for example, benzyl, 2-benzyl-2-propyl, β-phenyl-ethyl, α,α-dimethylbenzyl, ω-phenyl-butyl or ω-phenyl-hexyl. When C₇-C₁₂aralkyl is substituted, both the alkyl moiety and the aryl moiety of the aralkyl group can be substituted, the latter alternative being preferred.

C₆-C₁₀Aryl is, for example, phenyl, naphthyl or biphenylyl.

C₂-C₉Heteroaryl is an unsaturated or aromatic radical having 4n+2 conjugated π-electrons, for example 2-thienyl, 2-furyl, 2-pyridyl, 2-thiazolyl, 2-oxazolyl, 2-imidazolyl, isothiazolyl, thiadiazolyl, triazolyl, tetrazolyl or any other ring system consisting of thiophene, furan, pyridine, thiazole, thiadiazole, oxazole, imidazole, isothiazole, triazole, pyridine and benzene rings and unsubstituted or substituted by from 1 to 6 ethyl, methyl, ethylene and/or methylene substituents, for example benzotriazolyl, and in the case of N-heterocycles where applicable also in the form of their N-oxides.

C₂-C₁₂Heteroaralkyl is, for example, C₁-C₈alkyl substituted by C₁-C₁₁heteroaryl.

Furthermore, aryl and aralkyl can also be aromatic groups bonded to a metal, for example in the form of metallocenes of transition metals known per se, more especially

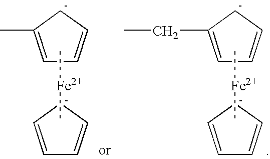

The compound of formula (I) may also be an anion which has been neutralised with a cation, for example when one or more sulfonate groups are present or when the metal M₁ has one or more excess negative charges, such as in Ce³⁺. Counter-ions are then, for example, Li⁺, Na⁺, K⁺, Rb⁺, Cs⁺, NH₄⁺, NH₃R₁₁⁺, NH₂R₁₁R₁₂⁺, NHRR₁₂R₁₃⁺, NR₈R₁₂R₁₃⁺, or ½ Mg²⁺, Ca²⁺, Sr²⁺, Ba²⁺, Zn²⁺ or ⅓ Al³⁺.

The compound of formula (I) may also be a cation which has been neutralised with an inorganic, organic or organometallic anion, for example when one or more ammonium groups are present or when the metal M₁ has one or more excess positive charges, such as in V⁵⁺. The inorganic, organic or organometallic anion may be, for example, the anion of a mineral acid, of the conjugated base of an organic acid (for example an alcoholate, phenolate, carboxylate, sulfonate or phosphonate) or an organometallic complex anion, for example fluoride, chloride, bromide, iodide, perchlorate, periodate, nitrate, hydrogen carbonate, ½ carbonate, ½ sulfate, C₁-C₄alkyl sulfate, hydrogen sulfate, ⅓ phosphate, ½ hydrogen phosphate, dihydrogen phosphate, ½ C₁-C₄alkanephosphonate, C₁-C₄alkane-C₁-C₁₂alkylphosphonate, di-C₁-C₄alkylphosphinate, tetrafluoroborate, hexafluorophcosphate, hexafluoroantimonate, acetate, trifluoroacetate, heptafluorobutyrate, ½ oxalate, methanesulfonate, trifluoromethanesulfonate, benzenesulfonate, tosylate, p-chlorobenzenesulfonate, p-nitrobenzenesulfonate, phenolate, benzoate or a negatively charged metal complex.

The person skilled in the art will readily recognise that it is also possible to use other anions with which he is familiar. It will be understood that

$$\frac{1}{x}$$

of an inorganic, organic or organometallic anion having x negative charges is a multiply charged anion which neutralises several singly charged cations or a cation having x charges, as the case may be, for example ½ SO₄²⁻.

Phenolates or carboxylates are, for example, of formula 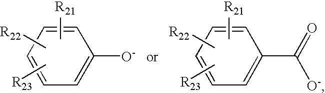
wherein R₂₁, R₂₂ and R₂₃ are each independently of the others hydrogen, R₇, or C₆-C₁₂aryl, C₄-C₁₂heteroaryl, C₇-C₁₂aralkyl or C₅-C₁₂heteroaralkyl each unsubstituted or substituted by one or more, where applicable identical or different, radicals R₇, for example anions of C₁-C₁₂alkylated, especially tert-C₄-C₈alkylated, phenols and benzoic acids, such as

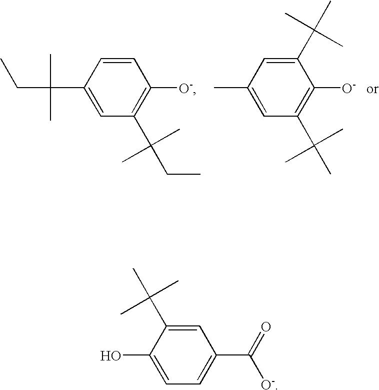

Preference is given to compounds of formula (I) wherein G₁ and G₂ are each independently of the other C(R₅);

M₁ is a lanthanide or transition metal of groups 4 to 7, especially Ti, Zr or Hf, more especially Zr;

\hat{P} is a phthalocyanino diradical of formula 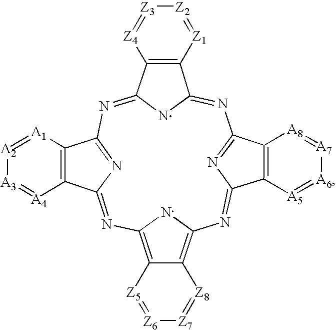
wherein A₁ to A₈ and Z₁ to Z₈ are all independently of one another N or CR₂₄, and each R₂₄ independently of the other R₂₄ is H or R₇; or two adjacent R₂₄ together are 1,4-buta-1,3-dienylene, 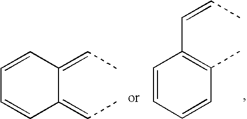
each of which is unsubstituted or substituted by one or more, where applicable identical or different, radicals R₇ and wherein 1 or 2 carbon(s) may have been replaced by nitrogen; and
Q₁ and Q₂ are O;
R₃ and R₄ are each independently of the other hydrogen, hydroxy, S—R₈, O—R₈, NH₂, NH—R₈, NR₈R₉; C₁-C₈alkyl, C₃-C₈cycloalkyl, C₂-C₈alkenyl or C₃-C₈cycloalkenyl each unsubstituted or substituted by one or more, where applicable identical or different, radicals R₆; or C₆-C₁₀aryl or C₁-C₉heteroaryl each unsubstituted or substituted by one or more, where applicable identical or different, radicals R₇;
R₅ is hydrogen or forms a 5- or 6-membered ring with R₁ or R₂;
R₆ is halogen, hydroxy, O—R₁₁, O—CO—R₁₁, oxo, NH₂, NH—R₁₁, NR₁₁R₁₂, or C₁-C₄alkoxy unsubstituted or mono- or poly-substituted by halogen; and
R₇ is halogen, nitro, cyano, thiocyano, S—R₈, O—R₈, NH₂, NH—R₈, NR₈R₉, NHCOR₈, N═CR₈R₉, N═CR₁₆R₁₇, CHO, CHOR₈OR₁₀, COR₉, CONR₈R₉, SO₂R₈, COOR₈, or C₁-C₅alkyl or C₁-C₅alkoxy each unsubstituted or substituted by one or more, where applicable identical or different, radicals R₆.
Formula (I) should be understood as follows: the two N. radicals are bonded to M₁, it being possible for the two other isoindole-N of \textcircled{P} additionally to be co-ordinated with M₁.

Special preference is given to compounds of formula (I) wherein G₁ and G₂ are each independently of the other C(R₅);

M₁ is Ti, Zr or Hf, more especially Zr;

\textcircled{P} is a phthalocyanino diradical of formula 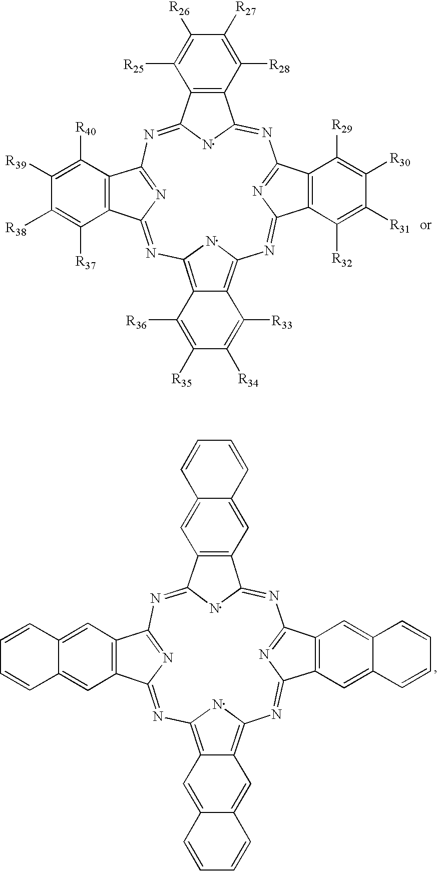
wherein R₂₅ to R₄₀ are all independently of one another H, halogen, O—R₈, S—R₈, O—CO—R₈, NH—R₈, NR₈R₉, CH₂OR₁₁, CH₂NR₁₁R₁₂, C(R₁₈)═CR₁₆R₁₇, CHO, CHOR₈OR₁₀, C(R₁₈)═NR₈, COR₉, CR₉OR₈OR₁₀, CN, COOH, COOR₈, CONH₂, CONHR₈, CONR₈R₉, SO₂R₈, SO₂NH₂, SO₂NHR₈, SO₂NR₈R₉, SO₃R₈, SiR₈R₉R₁₀, POR₈OR₁₀, P(═O)R₈R₁₀, P(═O)R₈OR₁₀, P(═O)OR₈OR₁₀, P(═O)(NH₂)₂, P(═O)(NHR₈)₂, P(═O)(NR₈R₉)₂, OPR₈R₁₀, OPR₈OR₁₀, OP(═O)R₈OR₁₀, OP(═O)OR₈OR₁₀ or OPO₃R₈, more especially H, halogen, O—R₈, O—CO—R₈, NH—R₈, NR₈R₉, CH₂OR₁₁ or CH₂NR₁₁R₁₂; and also
   Q₁ and Q₂ are O;
   R₁ and R₂ are each independently of the other C₁-C₅alkyl or C₂-C₅alkenyl, each of which is unsubstituted or substituted by one or more, where applicable identical or different, radicals R₆, or phenyl or C₂-C₅heteroaryl, each of which is unsubstituted or substituted by one or more, where applicable identical or different, radicals R₇;
   R₃ and R₄ are each independently of the other hydrogen, hydroxy, S—R₈, O—R₈, NH₂, NH—R₈, NR₈R₉, or C₁-C₅alkyl or C₂-C₅alkenyl each unsubstituted or substituted by one or more, where applicable identical or different, radicals R₆, or phenyl unsubstituted or substituted by one or more, where applicable identical or different, radicals R₇;
   R₅ is hydrogen or forms a 5- or 6-membered ring with R₁ or R₂;
   R₆ is halogen, hydroxy, O—R₁₁, oxo, NH₂, NH—R₁₁ or NR₁₁R₁₂; and
   R₇ is halogen, nitro, cyano, O—R₈, NH—R₈, NR₈R₉, CHO, CHOR₈OR₁₀, COR₉, CONR₈R₉, SO₂R₈, COOR₈, or C₁-C₅alkyl or C₁-C₅alkoxy each unsubstituted or substituted by one or more, where applicable identical or different, radicals R₆.

The recording layer advantageously comprises a compound of formula (I) or a mixture of such compounds as main component, for example at least 30% by weight, preferably at least 60% by weight, especially at least 80% by weight. Further customary constituents are possible, for example other chromophores (for example those disclosed in WO 01/75873, or others having an absorption maximum at from 300 to 1000 nm), stabilisers, ¹O₂-, triplet- or luminescence-quenchers, melting-point reducers, decomposition accelerators or any other additives that have already been described in optical recording media. Preferably, stabilisers or fluoresence-quenchers are added if desired.

When the recording layer comprises further chromophores, the amount of such chromophores should preferably be small, so that the absorption thereof at the wavelength of the inversion point of the longest-wavelength flank of the absorption of the entire solid layer is a fraction of the absorption of the pure compound of formula (I) in the entire solid layer at the same wavelength, advantageously at most ⅓, preferably at most ⅕, especially at most 1/10. The absorption maximum is preferably higher than 425 nm, especially higher than 500 nm, or may in some cases also be lower than the absorption maximum of the pure compound of formula (I).

Stabilisers and ¹O₂-, triplet- or luminescence-quenchers are, for example, metal complexes of N- or S-containing enolates, phenolates, bisphenolates, thiolates or bisthiolates or of azo, azomethine or formazan dyes, such as bis(4-dimethylamino-dithiobenzil)nickel [CAS N^{o} 38465-55-3], ®Irgalan Bordeaux EL, ®Cibafast N or similar compounds, hindered phenols and derivatives thereof (optionally also as counter-ions X), such as ®Cibafast AO, o-hydroxyphenyl-triazoles or -triazines or other UV absorbers, such as ®Cibafast W or ®Cibafast P or hindered amines (TEMPO or HALS, also as nitroxides or NOR-HALS, optionally also as counter-ions X), and also as cations diimmonium, Paraquat™ or Orthoquat™ salts, such as ®Kayasorb IRG 022, ®Kayasorb IRG 040, optionally also as radical ions, such as N,N,N′,N′-tetrakis(4-dibutylaminophenyl)-p-phenyleneamine-ammonium hexafluorophosphate, hexafluoroantimonate or perchlorate. The latter are available from Organica (Wolfen/DE); ®Kayasorb brands are available from Nippon Kayaku Co. Ltd., and ®Irgalan and ®Cibafast brands are available from Ciba Spezialitätenchemie AG.

Many such structures are known, some of them also in connection with optical recording media, for example from U.S. Pat. No. 5,219,707, JP-A-06/199 045, JP-A-07/76 169, JP-A-07/262,604 or JP-A-2000/272 241. They may be, for example, salts of the metal complex anions disclosed above with any desired cations, for example the cations disclosed above, or metal complexes, illustrated, for example, by a compound of formula

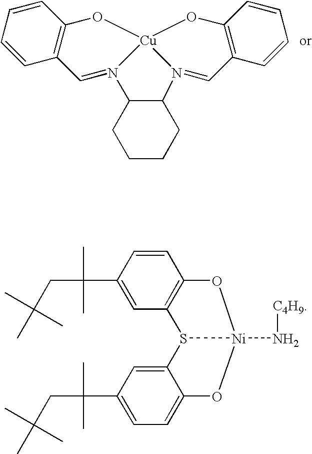

The person skilled in the art will know from other optical information media, or will easily identify, which additives in which concentration are particularly well suited to which purpose. Suitable concentrations of additives are, for example, from 0.001 to 1000% by weight, preferably from 1 to 50% by weight, based on the recording medium of formula (I).

The optical recording materials according to the invention exhibit excellent spectral properties of the solid amorphous recording layer. The refractive index is extra-ordinarily high. By virtue of an aggregation tendency in the solid that is surprisingly low for such compounds, the absorption band is narrow and intense, the absorption band being especially steep on the long-wavelength side. Crystallites are unexpectedly and very advantageously not formed or are formed only to a negligible extent. The reflectivity of the layers in the range of the writing and reading wavelength is very high in the unwritten state.

A very special advantage of the optical recording materials according to the invention is that error-free writing of very precise, readily readable marks is possible. In addition, the compounds used according to the invention decompose under the action of blue laser radiation above a reliable threshold rapidly and irreversibly within a narrow temperature range, so that the writing of marks is facilitated, but the media, once written, are not changed during reading of the information or by the effects of storage, for example exposure to sunlight.

By virtue of those excellent layer properties it is possible to obtain a rapid optical recording having high sensitivity, high reproducibility and geometrically very precise mark boundaries, the refractive index, the absorption and the reflectivity changing substantially, which gives a high degree of contrast. The differences in the mark lengths and the interval distances (“jitter”) are very small, which enables a high storage density to be obtained using a relatively thin recording channel with a relatively narrow track spacing (“pitch”). In addition, the recorded data are played back with an astonishingly low error rate, so that error correction requires only a small amount of storage space.

By virtue of the excellent solubility, including in apolar solvents, solutions can be used even in high concentrations without troublesome precipitation, for example during storage, so that problems during spin-coating are largely eliminated. This applies especially to compounds containing branched C₃-C₈alkyl.

Recording and playback can take place at the same wavelength, therefore advantageously requiring a simple optical system with a single laser source of advantageously from 350 to 500 nm, preferably from 370 to 450 nm. Especially preferred is the UV range from 370 to 390 nm, especially approximately 380 nm, or especially at the edge of the visible range of from 390 to 430 nm, more especially approximately 405±5 nm. In the field of compact, blue or violet laser diodes (such as Nichia GaN 405 nm) with an optical system of high numerical aperture, the marks can be so small and the tracks so narrow that up to about 20 to 25 Gb per recording layer is achievable on a 120 mm disc. At 380 nm it is possible to use indium-doped UV-VCSELs (Vertical-Cavity Surface-Emitting Laser), which laser source already exists as a prototype [Jung Han et al., see MRS Internet J. Nitride Semicond. Res. 5S1, W6.2 (2000)].

The invention therefore relates also to a method of recording or playing back data, wherein the data on an optical recording medium according to the invention are recorded or played back at a wavelength of from 350 to 500 nm.

The recording medium is based on the structure of known recording media and is, for example, analogous to those mentioned above. It may be composed, for example, of a transparent substrate, a recording layer comprising at least one compound of formula (I), a reflector layer and a covering layer, the writing and readout being effected through the substrate.

Suitable substrates are, for example, glass, minerals, ceramics and thermosetting and thermoplastic plastics. Preferred supports are glass and homo- or co-polymeric plastics. Suitable plastics are, for example, thermoplastic polycarbonates, polyamides, polyesters, polyacrylates and polymethacrylates, polyurethanes, polyolefins, polyvinyl chloride, polyvinylidene fluoride, polyimides, thermosetting polyesters and epoxy resins. Special preference is given to polycarbonate substrates which can be produced, for example, by injection-moulding. The substrate can be in pure form or may comprise customary additives, for example UV absorbers or dyes, as proposed e.g. in JP-A-04/167239 as light stabilisation for the recording layer. In the latter case it may be that in the range of the writing wavelength (emission wavelength of the laser) the dye added to the support substrate has no or at most only very low absorption, preferably up to a maximum of about 20% of the laser light focussed onto the recording layer.

The substrate is advantageously transparent over at least a portion of the range from 350 to 500 nm, so that it is permeable to, for example, at least 80% of the incident light of the writing or readout wavelength. The substrate is advantageously from 10 μm to 2 mm thick, preferably from 100 to 1200 μm thick, especially from 600 to 1100 μm thick, with a preferably spiral guide groove (track) on the coating side, a groove depth of from 10 to 200 nm, preferably from 80 to 150 nm, a groove width of from 100 to 400 nm, preferably from 150 to 250 nm, and a spacing between two turns of from 200 to 600 nm, preferably from 300 to 450 nm, especially from 300 to 350 nm. Grooves of different cross-sectional shape are known, for example rectangular, trapezoidal or V-shaped. Analogously to the known CD-R and DVD-R media, the guide groove may additionally undergo a small periodic or quasi-periodic lateral deflection (wobble), so that synchronisation of the speed of rotation and the absolute positioning of the reading head (pick-up) are made possible. Instead of, or in addition to, the deflection, the same function can be performed by markings between adjacent grooves (pre-pits).

The recording medium is applied, for example, by application of a solution by spin-coating, the objective being to produce a layer that is as amorphous as possible, the thickness of which layer is advantageously from 0 to 40 nm, preferably from 1 to 20 nm, especially from 2 to 10 nm, on the surface (“land”) and, depending upon the geometry of the groove, advantageously from 20 to 150 nm, preferably from 50 to 120 nm, especially from 60 to 100 nm, in the groove.

Reflecting materials suitable for the reflector layer include especially metals, which provide good reflection of the laser radiation used for recording and playback, for example the metals of Main Groups 3, 4 and 5 and of the Sub-Groups of the Periodic Table of the Elements. Al, In, Sn, Pb, Sb, Bi, Cu, Ag, Au, Zn, Cd, Hg, Sc, Y, La, Ti, Zr, Hf, V, Nb, Ta, Cr, Mo, W, Fe, Co, Ni, Ru, Rh, Pd, Os, Ir, Pt and the lanthanide metals Ce, Pr, Nd, Pm, Sm, Eu, Gd, Tb, Dy, Ho, Er, Tm, Yb and Lu and alloys thereof are especially suitable. On account of its high reflectivity and ease of production special preference is given to a reflective layer of aluminium, silver, gold or an alloy thereof (for example a white gold alloy), especially aluminium on economic and ecological grounds. The reflector layer is advantageously from 5 to 200 nm thick, preferably from 10 to 100 nm thick, especially from 40 to 60 nm thick, but reflector layers of greater thickness, for example 1 mm thick or even more, are also possible.

Materials suitable for the covering layer include chiefly plastics, which are applied in a thin layer to the reflector layer either directly or with the aid of adhesion promoters. It is advantageous to select mechanically and thermally stable plastics having good surface properties, which can be modified further, for example written on. The plastics may be thermosetting plastics and thermoplastic plastics. Directly applied covering layers are preferably radiation-cured (e.g. using UV radiation) coatings, which are particularly simple and economical to produce. A wide variety of radiation-curable materials are known. Examples of radiation-curable monomers and oligomers are acrylates and methacrylates of diols, triols and tetrols, polyimides of aromatic tetracarboxylic acids and aromatic diamines having C₁-C₄alkyl groups in at least two ortho-positions of the amino groups, and oligomers with dialkylmaleimidyl groups, e.g. dimethylmaleimidyl groups. For covering layers that are applied using adhesion promoters it is preferable to use the same materials as those used for the substrate layer, especially polycarbonates. The adhesion promoters used are preferably likewise radiation-curable monomers and oligomers. Instead of the covering layer applied using an adhesion promoter there may also be used a second substrate comprising a recording and reflector layer, so that the recording medium is playable on both sides. Preference is given to a symmetrical structure, the two parts being joined together at the reflector side by an adhesion promoter directly or by way of an intermediate layer.

In such a structure, the optical properties of the covering layer, or the covering materials, essentially do not play a part per se provided that, where applicable, curing thereof e.g. by UV radiation is achieved. The function of the covering layer is to ensure the mechanical strength of the recording medium as a whole and, if necessary, the mechanical strength of thin reflector layers. If the recording medium is sufficiently robust, for example when a thick reflector layer is present, it is even possible to dispense with the covering layer altogether. The thickness of the covering layer depends upon the thickness of the recording medium as a whole, which should preferably be a maximum of about 2 mm thick. The covering layer is preferably from 10 μm to 1 mm thick.

The recording media according to the invention may also have additional layers, for example interference layers or barrier layers. It is also possible to construct recording media having a plurality of (for example from two to ten) recording layers. The structure and the use of such materials are known to the person skilled in the art. Where present, interference layers are preferably arranged between the recording layer and the reflecting layer and/or between the recording layer and the substrate and consist of a dielectric material, for example, as described in EP-A-0 353 393, of TiO₂, Si₃N₄, ZnS or silicone resins.

The recording media according to the invention can be produced by processes known per se, it being possible for various methods of coating to be employed depending upon the materials used and their function.

Suitable coating methods are, for example, immersion, pouring, brush-coating, blade-application and spin-coating, as well as vapour-deposition methods carried out under a high vacuum. When, for example, pouring methods are used, solutions in organic solvents are generally employed. When solvents are employed, care should be taken that the supports used are insensitive to those solvents. Suitable coating methods and solvents are described, for example, in EP-A-0 401 791.

The recording layer is applied preferably by the application of a dye solution by spin-coating, solvents that have proved satisfactory being especially alcohols, e.g. 2-methoxyethanol, isopropanol or n-butanol, hydroxyketones, for example diacetone alcohol or 3-hydroxy-3-methyl-2-butanone, hydroxy esters, for example lactic acid methyl ester or isobutyric acid methyl ester, or preferably fluorinated alcohols, for example 2,2,2-trifluoroethanol or 2,2,3,3-tetrafluoro-1-propanol, and mixtures thereof. By virtue of the excellent solubility it is also possible, however, to use less polar or apolar solvents, for example ethers, such as dibutyl ether, saturated or unsaturated hydrocarbons, for example Tetralin or tert-butylbenzene, or possibly also ketones, such as 2,6-dimethyl-4-heptanone or 5-methyl-2-hexanone, especially in the form of mixtures or mixed components. If (in an inverse layer structure) the dye is coated onto a metallic reflector, it is also possible to use solvents that are aggressive towards the material of the support (acrylates, polycarbonate), such as chlorinated hydrocarbons or lower aromatic compounds, for example trichloroethylene, toluene or xylene. Further suitable solvents are disclosed, for example, in EP-A-0 483 387; this list is on no account complete, but the person skilled in the art will routinely try out any solvents with which he is familiar.

The application of the metallic reflector layer is preferably effected by sputtering or by vapour-deposition in vacuo. Such techniques are known and are described in specialist literature (e.g. J. L. Vossen and W. Kern, “Thin Film Processes”, Academic Press, 1978). The operation can advantageously be carried out continuously and achieves good reflectivity and a high degree of adhesiveness of the metallic reflector layer.

Recording is carried out in accordance with known methods by writing pits (marks) of fixed or variable length by means of a modulated, focussed laser beam guided at a constant or variable speed over the surface of the recording layer. Readout of information is carried out according to methods known per se by registering the change in reflection using laser radiation, for example as described in “CD-Player und R-DAT Recorder” (Claus Biaesch-Wiepke, Vogel Buchverlag, Wurzburg 1992). The person skilled in the art will be familiar with the requirements.

The information-containing medium according to the invention is especially an optical information material of the WORM type. It can be used, for example, analogously to CD-R (compact disc-recordable) or DVD-R (digital video disc-recordable) in computers, and also as storage material for identification and security cards or for the production of diffractive optical elements, for example holograms.

Alternatively, however, there are also recording media which differ substantially from CD-R and DVD-R and in which recording and playback take place not through the substrate but through the covering layer (“in-groove recording” and/or “on-groove recording”). Accordingly, the respective roles of the covering layer and the substrate, especially the geometry and the optical properties, are reversed in comparison with the structure described above. Analogous concepts are described a number of times in Proceedings SPIE-Int. Soc. Opt. Eng. 1999, 3864 for digital video recordings in conjunction with a blue GaN laser diode. For such recording media, which are especially suitable for a high storage density and have correspondingly small marks (“pits”), precise focussing is important, so that the manufacturing process, while essentially analogous, is considerably more awkward.

The compounds of formula (I) according to the invention, however, also meet the increased demands of an inverse layer structure surprisingly well. Preference is therefore given to an inverse layer structure having the layer sequence substrate, reflector layer, recording layer and covering layer. The recording layer is therefore located between the reflector layer and the covering layer. A thin covering layer approximately from 50 to 400 μm in thickness is especially advantageous (typically 100 μm at a numerical aperture of 0.85).

The recording and reflector layers in an inverse layer structure have in principle the same functions as indicated above. As with the groove geometry, they therefore usually have dimensions within the ranges indicated above.

The inverse layer structure requires particularly high standards, which the compounds used according to the invention fulfil astonishingly well, for example when the recording layer is applied to the metallic reflector layer and especially when a covering layer is applied to the recording layer, the covering layer being required to provide the recording layer with adequate protection against rubbing, photo-oxidation, fingermarks, moisture and other environmental effects and advantageously having a thickness in the range of from 0.01 to 0.5 mm, preferably in the range of from 0.05 to 0.2 mm, especially in the range of from 0.08 to 0.13 mm.

The covering layer preferably consists of a material that exhibits a transmission of 80% or above at the writing or readout wavelength of the laser. Suitable materials for the covering layer include, for exam pie, those materials mentioned above, but especially polycarbonate (such as Pure Ace® or Panlite®, Teijin Ltd), cellulose triacetate (such as Fujitac®, Fuji Photo Film) or polyethylene terephthalate (such as Lumirror®, Toray Industry), special preference being given to polycarbonate. Especially in the case of directly applied covering layers, radiation-cured coatings, such as those already described above, are advantageous, for example SD 347™ (Dainippon Ink).

The covering layer can be applied directly to the solid recording layer by means of a suitable adhesion promoter. In another embodiment, there is applied to the solid recording layer an additional, thin separating layer of a metallic, crosslinked organometallic or preferably dielectric inorganic material, for example in a thickness of from 0.001 to 10 μm, preferably from 0.005 to 1 μm, especially from 0.01 to 0.1 μm, for example from 0.05 to 0.08 μm in the case of dielectric separating layers and from 0.01 to 0.03 μm in the case of metallic separating layers. Separating layers and corresponding methods are disclosed in WO 02/082 438, to which reference is expressly made here. If desired, such coatings can be applied, for example, in the same thickness also between the support material and the metallic reflector layer or between the metallic reflector layer and the optical recording layer. This may be advantageous in certain cases, for example when a silver reflector is used in combination with sulfur-containing additives in the recording layer.

In a special variant, there is applied to the solid recording layer an additional, thin separating layer of a metallic, crosslinked organometallic or dielectric inorganic material, for example in a thickness of from 0.001 to 10 μm, preferably from 0.005 to 1 μm, especially from 0.01 to 0.1 μm. On account of their high reflectivity, metallic separating layers should advantageously be a maximum of 0.03 μm thick. Separating layers and corresponding methods are disclosed in WO 02/082 438, to which reference is expressly made here.

Some of the compounds used according to the invention are known from J. Porphyrins Phthalocyanines 5, 731-734 (2001) and J. Porphyrins Phthalocyanines 6, 114-121 (2002).

Analogously to the known compounds it is also possible, however, to prepare new compounds which can be used according to the invention in optical recording media. The invention therefore relates also to novel compounds of formula (I). It will be understood that mixtures of compounds of formula (I) can also be used.

Instead of being prepared by mixing together the components, mixtures can also be prepared especially advantageously by mixed synthesis, wherein, for example, first a metal and then a metal-free phthalocyanine are added to the pre-prepared mixture of the ligands of formulae 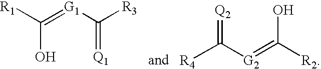
The mixtures prepared by mixed synthesis generally have somewhat better solubility than physical mixtures because they contain a greater number of asymmetric components.

In addition to comprising one or more compounds of formula (I) and optionally customary additives, the optical recording media according to the invention may also comprise other chromophores, preferably metal-free chromophores. Other chromophores may, if desired, be added in an amount of from 1 to 200% by weight, based on the total of the compounds of formula (I). The amount of other chromophores is preferably from 5 to 100% by weight, especially from 10 to 50% by weight, based on the total of the compounds of formula (I). Chromophores can be dyes or UV absorbers, preferably having an absorption maximum of from 350 to 400 nm or at from 600 to 700 nm, for example around 380 or 630 nm.

Especially preferred additional metal-free chromophores are cyanines, azacyanines, merocyanines and oxonols and also rhodamines, for example those disclosed in WO 04/006 878, WO 02/082 4 38 or EP-A-1 083 555, and also 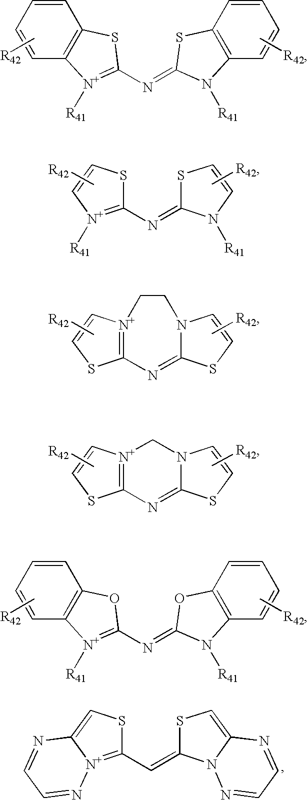
wherein R₄₁ is C₁-C₂₄alkyl or C₂-C₂₄alkenyl, each of which can be unsubstituted or substituted, and R₄₂ is any substituent. R₄₁ may be, for example, methyl, ethyl, vinyl, allyl, isopropyl, n-butyl, 2-isopropyloxy-ethyl, n-pentyl, 3-methyl-butyl, 3,3-dimethylbutyl, 2-ethyl-hexyl, 2-cyano-ethyl, furan-2-yl-methyl or 2-hydroxy-methyl; R₄₂ is, for example, C₆-C₁₀aryl, C₁-C₂₄alkyl or C₂-C₂₄alkenyl.

Purely illustrative examples of such chromophores are:

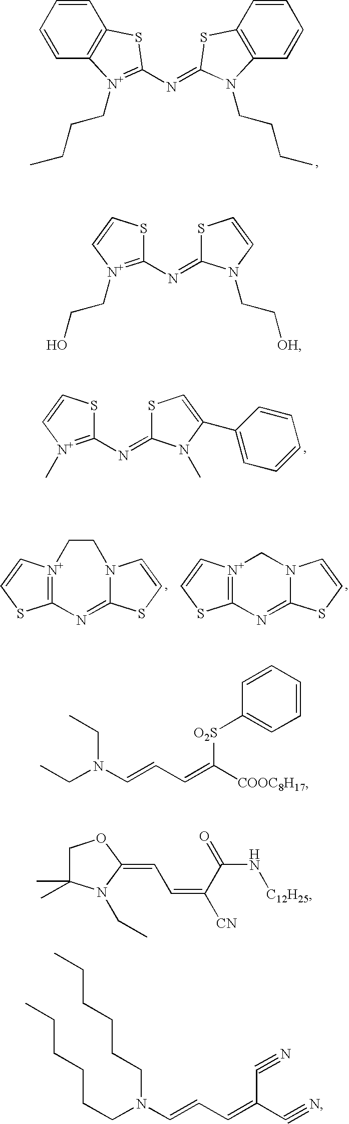

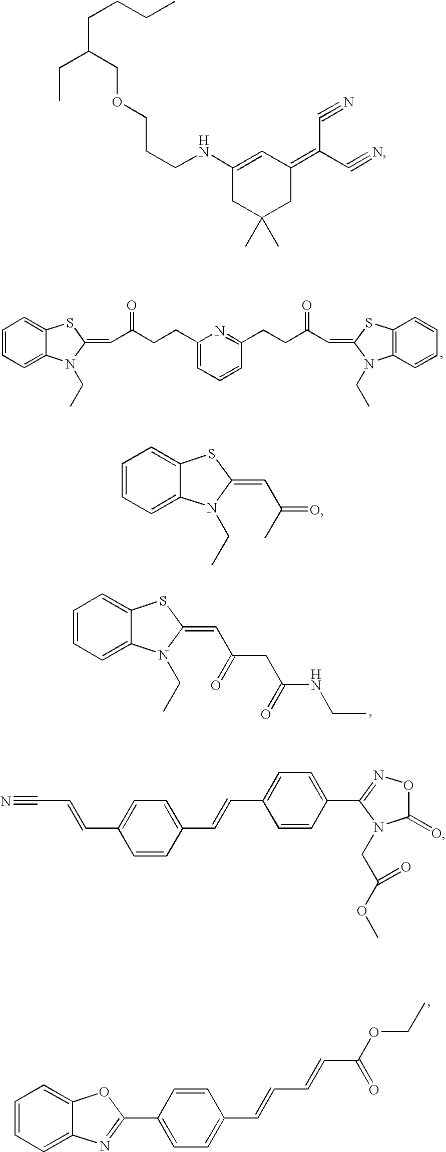

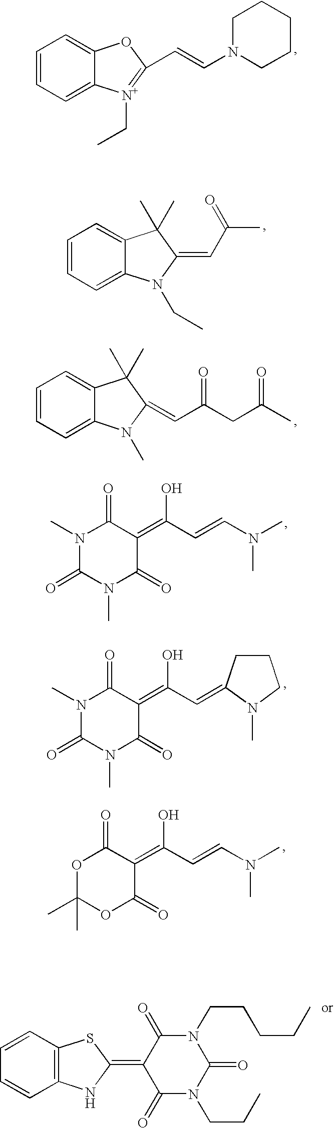

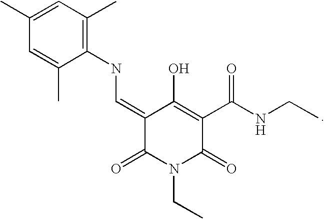

The following examples illustrate the invention but do not limit the scope thereof (unless otherwise indicated, “%” always refers to % by weight):

### EXAMPLE 1

1.0 g of the compound of formula 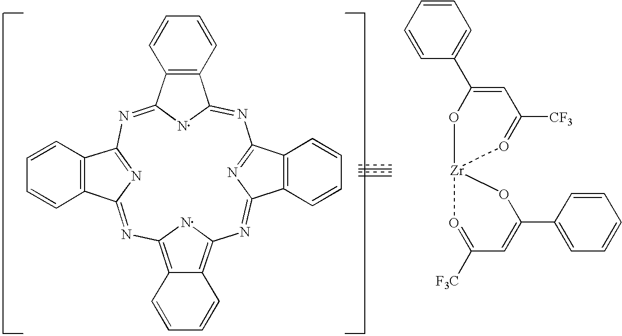
(UV/VIS in toluene: λₘₐₓ=691 nm, ε=161300 l·mol⁻¹·cm⁻¹; λₘₐₓ=334 nm, ε=138000 l·mol⁻¹·cm⁻¹) are dissolved in 99 g of toluene and filtered through a 0.2 μm Teflon filter. The dye solution is then applied to a 1.2 mm thick, flat polycarbonate plate (diameter 120 mm) by rotation at 250 rev/min. The rotational speed is then increased to 1200 rev/min, so that the excess solution is spun off, and a uniform solid layer is formed. After drying, the solid layer has an absorption of 0.54 at 355 nm. Using an optical measuring system (ETA-RT, STEAG ETA-Optik), the layer thickness and the refractive index are determined. At 405 nm the dye layer has a layer thickness of 29 nm, a refractive index n of 1.97 and an extinction coefficient k of 0.060.

### EXAMPLE 2

The procedure is as in Example 1, but the compound of the following 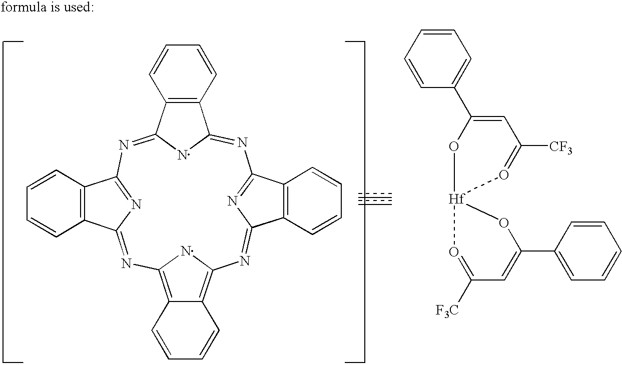
(UV/VIS in toluene: λₘₐₓ=690 nm, ε=173 860 l·mol⁻¹·cm⁻¹; λₘₐₓ=334 nm, ε=131 800 l·mol⁻¹·cm⁻¹). After drying, the uniform, 33.5 nm thick solid layer has an absorption of 0.45 at 333 nm. At 405 nm the dye layer has a refractive index n of 1.89 and an extinction coefficient k of 0.042.

### EXAMPLE 3

In a vacuum-coating apparatus (Twister™, Balzers Unaxis), a 80 nm thick silver reflector layer is applied to a 1.15 mm thick, grooved polycarbonate disc (diameter 120 mm, groove depth 21 nm, track width 150 nm, track pitch 320 nm). 20.0 g of the compound according to Example 1 are dissolved in 1000 ml of 4-methyl-cyclohexanone and filtered through a 0.2 μm Teflon™ filter. The resulting solution is applied to the reflector layer by spin-coating. After drying (15 minutes, 70° C.), the solid layer has an absorption of 0.47 at 335 nm (taking account of the inherent absorption of the silver layer). A 40 nm thick layer of silicon oxynitride (SiON [12594-30-8]) is then applied thereto by RF-sputtering in a vacuum-coating apparatus (Cube, Balzers Unaxis). For protecting the recording layer, a pressure-sensitive-adhesive polycarbonate film of total thickness 97 μm (Nitto Denko, Japan) is laminated over the sputtered SiON dielectric layer. Using a laser apparatus (ODU-1000™ for Blu-ray™ Disc, Pulstec, Japan) of wavelength 407 nm and an objective lens numerical aperture of 0.85, marks are written into the active layer at a power of 8 mW and a linear speed of 5.28 m/s. This process brings about a significant reduction in reflection at the written sites (modulation I8/I8H=0.47).

The marks are then read with the laser power reduced to 0.3 mW, the following parameters being obtained: modulation I8pp/I8H=0.45; I2pp/I8pp=0.17; CNR=46.9 dB; crosstalk=18 dB.

### EXAMPLE 4

Example 3 is repeated, but this time marks are written at a power of 10 mW.

### COMPARISON EXAMPLE

In parallel with Example 4, a procedure exactly the same as in Example 4 is followed, but instead of the compound according to Example 1 there is used the compound of formula 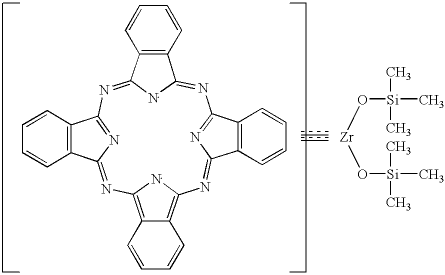
(corresponding to Example 22 of WO-03/030 158). In addition, in order to achieve absorption of 0.47 (at 340 nm) comparable with Example 4, the spin-coating is carried out at a slower speed.

Using a laser apparatus (ODU 1000™ for Blu-ray™ Disc/Pulstec, Japan) of wavelength 407 nm and an objective lens numerical aperture of 0.85, marks are written into the active layer at a power of 10 mW and a linear speed of 5.28 m/s. The marks are then read with the laser power reduced to 0.3 mW.

In comparison with Example 4, all the relevant values are significantly worse: modulation 23% lower; CNR 11% lower; crosstalk 22% higher.

In addition, it is extremely disadvantageous that the speed of the spin-coating has to be reduced in order to achieve optimum absorption, because the system costs are high and fewer discs can then be produced on a production line in the same period of time.

Although every effort was made, it was not possible to prepare compound 14 according to Example 8 of JP-A-09/226 248.

1. An optical recording medium comprising a substrate, a recording layer and optionally one or more reflecting layers, wherein the recording layer comprises a compound of formula 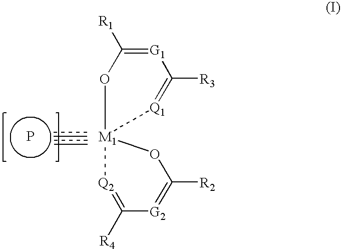
(I) or a tautomeric or mesomeric form thereof,
wherein
G₁ and G₂ are each independently of the other C(R₅) or N;
M₁ is a lanthanide or transition metal of groups 4 to 10;
\textcircled{P} is a phthalocyanino diradical;
Q₁ and Q₂ are each independently of the other O or S,
R₁ and R₂ are each independently of the other C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₀aryl, C₁-C₉heteroaryl, C₇-C₁₂aralkyl or C₂-C₁₂heteroaralkyl each unsubstituted or substituted by one or more, where applicable identical or different, radicals R₇;
R₃ and R₄ are each independently of the other hydrogen, hydroxy, S—R₈, O—R₈, O—CO—R₈, OCOOR₈, NH₂, NH—R₈, NR₈R₉, NHCOR₈, NR₈COR₁₀, NHCOOR₈, NR₈COOR₁₀, ureido, NR₈—CO—NHR₁₀, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₀aryl, C₁-C₉heteroaryl, C₇-C₁₂aralkyl or C₂-C₁₂heteroaralkyl each unsubstituted or substituted by one or more, where applicable identical or different, radicals R₇;
each R₅, independently of any other R₅, is hydrogen, or C₁-C₁₂alkyl, C₃-C₁₂cycloalkyl, C₂-C₁₂alkenyl or C₃-C₁₂cycloalkenyl each unsubstituted or substituted by one or more, where applicable identical or different, radicals R₆, or C₆-C₁₀aryl, C₁-C₉heteroaryl, C₇-C₁₂aralkyl or C₂-C₁₂heteroaralkyl each unsubstituted or substituted by one or more, where applicable identical or different, radicals R₇; wherein R₁ and R₂, R₂ and R₃, R₃ and R₄ or R₁ and R₄ can be linked by a bonding member, or two of R₁, R₂, R₃ and R₄ can each be linked by a bonding member to one of the two other R₁, R₂, R₃ and R₄ to form pairs, and each bonding member is a direct bond or a bridge O, S or N(R₈); or
R₁ forms with R₅ of G₁ and/or R₃ forms with R₅ of G₂ a saturated, mono- or poly-unsaturated or aromatic 5- or 6-membered ring which may optionally contain 1, 2 or 3 identical or different hetero atoms —O—, —S—, —N═ or —N(R₈)—, which ring is unsubstituted or substituted by one or more, where applicable identical or different, radicals R₇; and/or
R₂ forms with R₅ of G₁ and/or R₄ forms with R₅ of G₂ a saturated or mono- or poly-unsaturated 5- or 6-membered ring which may optionally contain 1, 2 or 3 identical or different hetero atoms —O—, —S—, —N═ or —N(R₈)—, which ring is unsubstituted or substituted by one or more, where applicable identical or different, radicals R₆;
R₆ is halogen, hydroxy, O—R₁₁, O—CO—R₁₁, oxo, S—R₁₁, thioxo, NH₂, NH—R₁₁, NR₁₁R₁₂, NH₃⁺, NH₂R₁₁⁺, NHR₁₁R₁₂⁺, NR₁₁R₁₂R₁₃⁺, NR₁₁—CO—R₁₃, NR₁₁COOR₁₃, cyano, formyl, COO—R₁₁, carboxy, carbamoyl, CONH—R₁₁, CONR₁₁R₁₂, ureido, NH—CO—NHR₁₃, NR₁₁—CO—NHR₁₃, phosphato, P(═O)R₁₁R₁₃, POR₁₁OR₁₃, OPR₁₁R₁₃, OPR₁₁OR₁₃, P(═O)R₁₁OR₁₃, P(═O)OR₁₁OR₁₃, OP(═O)R₁₁OR₁₃, OP(═O)OR₁₁OR₁₃, OPO₃R₁₁, SO₂R₁₁, sulfato, sulfo, R₁₄, N═N—R₁₄, or C₁-C₈alkoxy or C₃-C₈cycloalkoxy each unsubstituted or mono- or poly-substituted by halogen;
R₇, independently of any other R₇, is R₁₅, halogen, nitro, cyano, thiocyano, hydroxy, S—R₈, O—R₈, O—CO—R₈, OCOOR₈, NH₂, NH—R₈, NR₈R₉, NHCOR₈, NR₈COR₁₀, NHCOOR₈, NR₈COOR₁₀, ureido, NR₈—CO—NHR₁₀, NH₃⁺, NH₂R₈⁺, NHR₈R₉⁺, NR₈R₉R₁₀⁺, N═N—R₁₅, N═CR₈R₉, N═CR₁₆R₁₇, C(R₁₈)═NR₈, C(R₁₈)═NR₁₆, C(R₁₈)═CR₁₆R₁₇, CHO, CHOR₈OR₁₀, COR₉, CR₉OR₈OR₁₀, CONH₂, CONHR₈, CONR₈R₉, SO₂R₈, SO₃R₈, SO₂NH₂, SO₂NHR₈, SO₂NR₈R₉, COOH, COOR₈, B(OH)₂, B(OH)(OR₈), B(OR₈)OR₁₀, phosphato, P(═O)R₈R₁₀, POR₈OR₁₀, P(═O)R₈OR₁₀, P(═O)OR₈OR₁₀, OPR₈R₁₀, OPR₈OR₁₀, OP(═O)R₈OR₁₀, OP(═O)OR₈OR₁₀, OPO₃R₈, sulfato, sulfo, or C₁-C₅alkyl, C₃-C₆cycloalkyl, C₁-C₅alkylthio, C₃-C₆cycloalkylthio, C₁-C₅alkoxy or C₃-C₆cycloalkoxy each unsubstituted or substituted by one or more, where applicable identical or different, radicals R₆;
R₈, R₉ and R₁₀ are each independently of the others R₁₅, R₁₉—[O—C₁-C₄alkylene]ₘ, R₁₉—[NH—C₁-C₄alkylene]ₘ, or C₁-C₈alkyl, C₃-C₈cycloalkyl, C₂-C₈alkenyl or C₃-C₈cycloalkenyl each unsubstituted or substituted by one or more, where applicable identical or different, halogen, hydroxy, C₁-C₅alkoxy or C₃-C₆cycloalkoxy radicals; or
R₈ and R₉ together with the common nitrogen are pyrrolidine, piperidine, piperazine or morpholine, each of which is unsubstituted or mono- to tetra-substituted by C₁-C₄alkyl; or
R₈ and R₁₀ together are C₂-C₈alkylene, C₃-C₈cycloalkylene, C₂-C₈alkenylene or C₃-C₈cycloalkenylene, each of which is unsubstituted or substituted by one or more, where applicable identical or different, halogen, hydroxy, C₁-C₅alkoxy or C₃-C₆cycloalkoxy radicals;
R₁₁, R₁₂ and R₁₃ are each independently of the others C₁-C₈alkyl, C₃-C₈cycloalkyl, C₂-C₈alkenyl, C₃-C₈cycloalkenyl, R₁₉—[O—C₁-C₄alkylene]ₘ, R₁₉—[NH—C₁-C₄alkylene]ₘ, C₆-C₁₀aryl, C₄-C₉heteroaryl, C₇-C₁₀aralkyl or C₅-C₉heteroaralkyl; or
R₁₁ and R₁₂ together with the common nitrogen are pyrrolidine, piperidine, piperazine or morpholine, each of which is unsubstituted or mono- to tetra-substituted by C₁-C₄alkyl;
R₁₄ is C₆-C₁₂aryl, C₄-C₁₂heteroaryl, C₇-C₁₂aralkyl or C₅-C₁₂heteroaralkyl, each of which is unsubstituted or substituted by one or more, where applicable identical or different, radicals R₇;
R₁₅ is phenyl, C₄-C₅heteroaryl, C₇-C₈aralkyl or C₅-C₇heteroaralkyl, each of which is unsubstituted or substituted by one or more, where applicable identical or different, radicals R₂₀;
R₁₆ and R₁₇ are each independently of the other NR₁₁R₁₂, CN, CONH₂, CONHR₈, CONR₈R₉ or COOR₉;
R₁₈ is R₁₅, hydrogen, cyano, hydroxy, C₁-C₁₂alkoxy, C₃-C₁₂cycloalkoxy, C₁-C₁₂alkylthio, C₃-C₁₂cycloalkylthio, amino, NHR₁₃, NR₁₁R₁₂, halogen, nitro, formyl, COO—R₁₁, carboxy, carbamoyl, CONH—R₁₁, CONR₁₁R₁₂, or C₁-C₈alkyl, C₃-C₈cycloalkyl, C₂-C₈alkenyl or C₃-C₈cycloalkenyl each unsubstituted or substituted by one or more, where applicable identical or different, halogen, hydroxy, C₁-C₅alkoxy or C₃-C₆cycloalkoxy radicals; or
R₈ and R₁₈ together are C₂-C₈alkylene, C₃-C₈cycloalkylene, C₂-C₈alkenylene or C₃-C₈cycloalkenylene, each of which is unsubstituted or substituted by one or more, where applicable identical or different, halogen, hydroxy, C₁-C₅alkoxy or C₃-C₆cycloalkoxy radicals;
R₁₉ is hydrogen, C₁-C₄alkyl or C₁-C₃alkylcarbonyl;
R₂₀ is nitro, SO₂NHR₁₁, SO₂NR₁₁R₁₂, or C₁-C₈alkyl, C₃-C₈cycloalkyl, C₁-C₈alkylthio, C₃-C₈cycloalkylthio, C₁-C₈alkoxy or C₃-C₈cycloalkoxy each unsubstituted or substituted by one or more, where applicable identical or different, halogen, hydroxy, C₁-C₅alkoxy or C₃-C₆cycloalkoxy radicals; and
m is a number from 1 to 4.

2. An optical recording medium according to claim 1, wherein G₁ and G₂ are each independently of the other C(R₅);
M₁ is a lanthanide or transition metal of groups 4 to 7; \textcircled{P} is a phthalocyanino diradical of formula 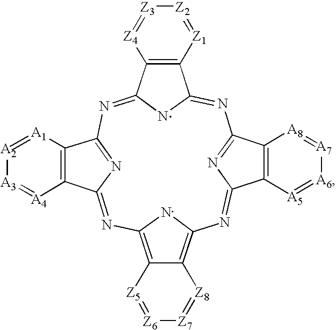
wherein A₁ to A₈ and Z₁ to Z₈ are all independently of one another N or CR₂₄, and each R₂₄ independently of the other R₂₄ is H or
R₇; or two adjacent R₂₄ together are 1,4-buta-1,3-dienylene, 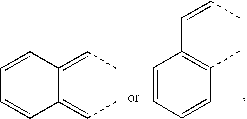
each of which is unsubstituted or substituted by one or more, where applicable identical or different, radicals R₇ and wherein 1 or 2 carbon(s) may have been replaced by nitrogen; and
Q₁ and Q₂ are O;
R₃ and R₄ are each independently of the other hydrogen, hydroxy, S—R₈, O—R₈, NH₂, NH—R₈, NR₈R₉; C₁-C₈alkyl, C₃-C₈cycloalkyl, C₂-C₈alkenyl or C₃-C₈cycloalkenyl each unsubstituted or substituted by one or more, where applicable identical or different, radicals R₆; or C₆-C₁₀aryl or C₁-C₉heteroaryl each unsubstituted or substituted by one or more, where applicable identical or different, radicals R₇;
R₅ is hydrogen or forms a 5- or 6-membered ring with R₁ or R₂;
R₆ is halogen, hydroxy, O—R₁₁, O—CO—R₁₁, oxo, NH₂, NH—R₁₁, NR₁₁R₁₂, or C₁-C₄alkoxy unsubstituted or mono- or poly-substituted by halogen; and
R₇ is halogen, nitro, cyano, thiocyano, S—R₈, O—R₈, NH₂, NH—R₈, NR₈R₉, NHCOR₈, N═CR₈R₉, N═CR₁₆R₁₇, CHO, CHOR₈OR₁₀, COR₉, CONR₈R₉, SO₂R₈, COOR₈, or C₁-C₅alkyl or C₁-C₅alkoxy each unsubstituted or substituted by one or more, where applicable identical or different, radicals R₆.

3. An optical recording medium according to claim 1, wherein G₁ and G₂ are each independently of the other C(R₅);
M₁ is Ti, Zr or Hf;
\textcircled{P} is a phthalocyanino diradical of formula 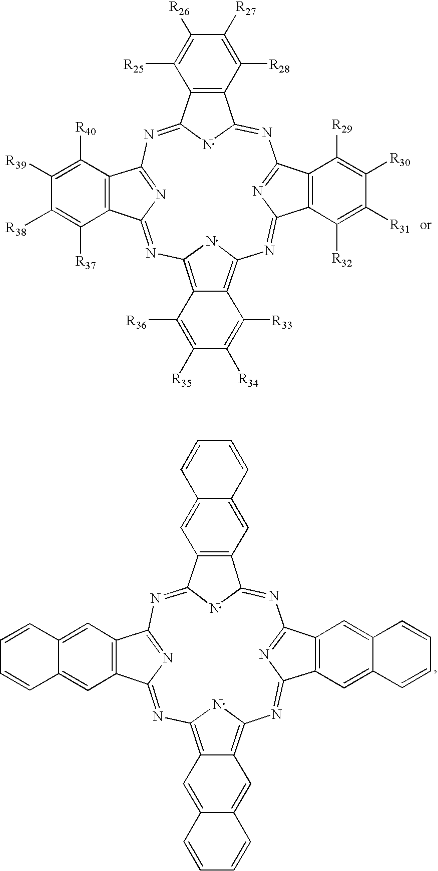
wherein R₂₅ to R₄₀ are all independently of one another H, halogen, O—R₈, S—R₈, O—CO—R₈, NH—R₈, NR₈R₉, CH₂OR₁₁, CH₂NR₁₁R₁₂, C(R₁₈)═CR₁₆R₁₇, CHO, CHOR₈R₁₀, C(R₁₈)═NR₈, COR₉, CR₉OR₈OR₁₀, CN, COOH, COOR₈, CONH₂, CONHR₈, CONR₈R₉, SO₂R₈, SO₂NH₂, SO₂NHR₈, SO₂NR₈R₉, SO₃R₈, SiR₈R₉R₁₀, POR₈OR₁₀, P(═O)R₈R₁₀, P(═O)R₈OR₁₀, P(═O)OR₈OR₁₀, P(═O)(NH₂)₂, P(═O)(NHR₈)₂, P(═O)(NR₈R₉)₂, OPR₈R₁₀, OPR₈OR₁₀, OP(═O)R₈OR₁₀, OP(═O)OR₈OR₁₀ or OPO₃R₈, more especially H, halogen, O—R₈, O—CO—R₈, NH—R₈, NR₈R₉, CH₂OR₁₁ or CH₂NR₁₁R₁₂; and also
Q₁ and Q₂ are O;
R₁ and R₂ are each independently of the other C₁-C₅alkyl or C₂-C₅alkenyl, each of which is unsubstituted or substituted by one or more, where applicable identical or different, radicals R₆, or phenyl or C₂-C₅heteroaryl, each of which is unsubstituted or substituted by one or more, where applicable identical or different, radicals R₇;
R₃ and R₄ are each independently of the other hydrogen, hydroxy, S—R₈, O—R₈, NH₂, NH—R₈, NR₈R₉, or C₁-C₅alkyl or C₂-C₅alkenyl each unsubstituted or substituted by one or more, where applicable identical or different, radicals R₆, or phenyl unsubstituted or substituted by one or more, where applicable identical or different, radicals R₇;
R₅ is hydrogen or forms a 5- or 6-membered ring with R₁ or R₂;
R₆ is halogen, hydroxy, O—R₁₁, oxo, NH₂, NH—R₁₁ or NR₁₁R₁₂; and
R₇ is halogen, nitro, cyano, O—R₈, NH—R₈, NR₈R₉, CHO, CHOR₈OR₁₀, COR₉, CONR₈R₉, SO₂R₈, COOR₈, or C₁-C₅alkyl or C₁-C₅alkoxy each unsubstituted or substituted by one or more, where applicable identical or different, radicals R₆.

4. An optical recording medium according to claim 1, wherein the compound of formula (I) contains branched C₃-C₁₂alkyl or branched C₃-C₁₂alkenyl.

5. An optical recording medium according to claim 1, wherein the recording layer is substantially amorphous.

6. An optical recording medium according to claim 1, additionally comprising a covering layer, wherein substrate, reflector layer, recording layer and covering layer are arranged in that order.

7. An optical recording medium according to claim 1, which in addition to comprising a compound of formula (I) comprises a metal-free chromophore.

8. An optical recording medium according to claim 1, wherein the compound of formula (I) is substantially amorphous.

9. A method of producing an optical recording medium according to claim 1, wherein a solution of a compound of formula (I) according to claim 1 is applied by spin-coating to a grooved substrate.

10. A method of recording or playing back data, wherein the data on an optical recording medium according to claim 1, are recorded or played back at a wavelength of from 350 to 500 nm.

11. An optical recording medium according to claim 2, wherein M₁ is Ti, Zr or Hf.

12. An optical recording medium according to claim 11, wherein M₁ is Zr.

13. An optical recording medium according to claim 3, wherein M₁ is Ti, Zr or Hf.

14. An optical recording medium according to claim 13, wherein M₁ is Zr.
